(19) United States
(12) Patent Application Publication
(10) Pub. No.: US 2004/0253489 A1
(43) Pub. Date: Dec. 16, 2004

(54) Technique and apparatus to control a fuel cell system

(76) Inventors: Thomas J. Horgan, Gansevoort, NY (US); Rebecca A. Dinan, Troy, NY (US)

Correspondence Address: TROP PRUNER & HU, PC, 8554 KATY FREEWAY, SUITE 100, HOUSTON, TX, 77024, US

(21) Appl. No.: 10/459,754

(22) Filed: Jun. 12, 2003

(51) Int. Cl. H01M 8/00; H01M 8/18; H01M 8/04; H01M 8/10; H01M 8/12

(52) U.S. Cl. 429/13; 429/32; 429/19; 429/23

(57) ABSTRACT

A technique that is usable with a fuel cell system includes using the fuel cell system to provide power to a load. The technique includes providing a model that indicates a future power demand from the load and regulating an operation of the fuel cell system in response to the future power demand that is indicated by the model.

### BACKGROUND

The invention generally relates to a technique and apparatus to control a fuel cell system.

A fuel cell is an electrochemical device that converts chemical energy that is produced by a reaction directly into electrical energy. For example, one type of fuel cell includes a polymer electrolyte membrane (PEM), often called a proton exchange membrane, that permits only protons to pass between an anode and a cathode of the fuel cell. At the anode, diatomic hydrogen (a fuel) is reacted to produce hydrogen protons that pass through the PEM. The electrons produced by this reaction travel through circuitry that is external to the fuel cell to form an electrical current. At the cathode, oxygen is reduced and reacts with the hydrogen protons to form water. The anodic and cathodic reactions are described by the following relationships:

H₂→2H⁺+2e⁻ Eq. 1

at the anode of the cell, and

O₂+4H⁺+4e⁻→2H₂O Eq. 2

at the cathode of the cell.

A typical fuel cell has a terminal voltage near one volt DC. For purposes of producing much larger voltages, several fuel cells may be assembled together to form a fuel cell stack, an arrangement in which the fuel cells are electrically coupled together in series to form a larger DC voltage (a voltage near 100 volts DC, for example) and to provide more power.

The fuel cell stack may include flow plates (graphite composite or metal plates, as examples) that are stacked one on top of the other, and each plate may be associated with more than one fuel cell of the stack. The plates may include various surface flow channels and orifices to, as examples, route the reactants and products through the fuel cell stack. Several PEMs (each one being associated with a particular fuel cell) may be dispersed throughout the stack between the anodes and cathodes of the different fuel cells. Electrically conductive gas diffusion layers (GDLs) may be located on each side of each PEM to form the anode and cathodes of each fuel cell. In this manner, reactant gases from each side of the PEM may leave the flow channels and diffuse through the GDLs to reach the PEM.

A typical fuel cell system may include, among other components, a fuel cell stack and a fuel processor that converts a hydrocarbon (natural gas or propane, as examples) into a fuel flow for the stack. Ideally, the fuel processor furnishes the appropriate fuel flow rate to the stack to satisfy the stoichiometric ratios (pursuant to the chemical equations stated above) for the power that is demanded by the load that is connected to the fuel cell system. However, the power that is demanded by the load typically is not constant with respect to time, but rather, the power requirements of the load may vary according to the time of day, weather conditions, etc.

The fuel processor typically has a transient response time which means the fuel processor is not capable of instantaneously increasing the fuel flow rate to the appropriate level to respond to a sudden increase in the power that is demanded from the load. Thus, due to the lack of a sufficient rate of incoming fuel, there are periods of time in which the fuel cell stack may momentarily fail to produce enough power to satisfy the power demand. To accommodate such times, the fuel cell system may include batteries that sever as buffers to temporarily supplement the power that is provided by the fuel cell stack until the fuel processor produces the appropriate fuel flow rate to meet the load's power demand.

The batteries store a finite amount of energy. Therefore, to ensure that the fuel cell system can always meet the power requirements of the load, the fuel cell system operates to keep its batteries at a relatively high state of charge at all times in preparation for power surges. However, maintaining the batteries in this high state of charge often results in the overcharging of the batteries. This overcharging, in turn, typically degrades the power efficiency of the fuel cell system and results in accelerated performance degradation of the system.

Thus, there is a continuing need for an arrangement and/or technique to address one or more of the problems that are set forth above as well as possibly address one or more problems that are not set forth above.

### SUMMARY

In an embodiment of the invention, a technique that is usable with a fuel cell system includes using the fuel cell system to provide power to a load. The technique includes providing a model that indicates a future power demand from the load and regulating an operation of the fuel cell system in response to the future power demand that is indicated by the model.

Advantages and other features of the invention will become apparent from the following description, drawing and claims.

### BRIEF DESCRIPTION OF THE DRAWING

FIG. 1 is a schematic of a fuel cell system according to an embodiment of the invention.

FIG. 2 is a flow chart depicting a technique to control the fuel cell system in response to a future power demand indicated by a predictive model according to an embodiment of the invention.

FIG. 3 is a flow chart depicting a technique to update the predictive model according to an embodiment of the invention.

FIG. 4 is a block diagram depicting an architecture of the predictive model according to an embodiment of the invention.

FIG. 5 is a table depicting power demand predictions from the predictive model for different model parameters.

FIGS. 6, 7, 8 and 9 are graphs that each depicts a power demand predicted by a predictive model and the actual power over the same time period for various embodiments of the invention.

### DETAILED DESCRIPTION

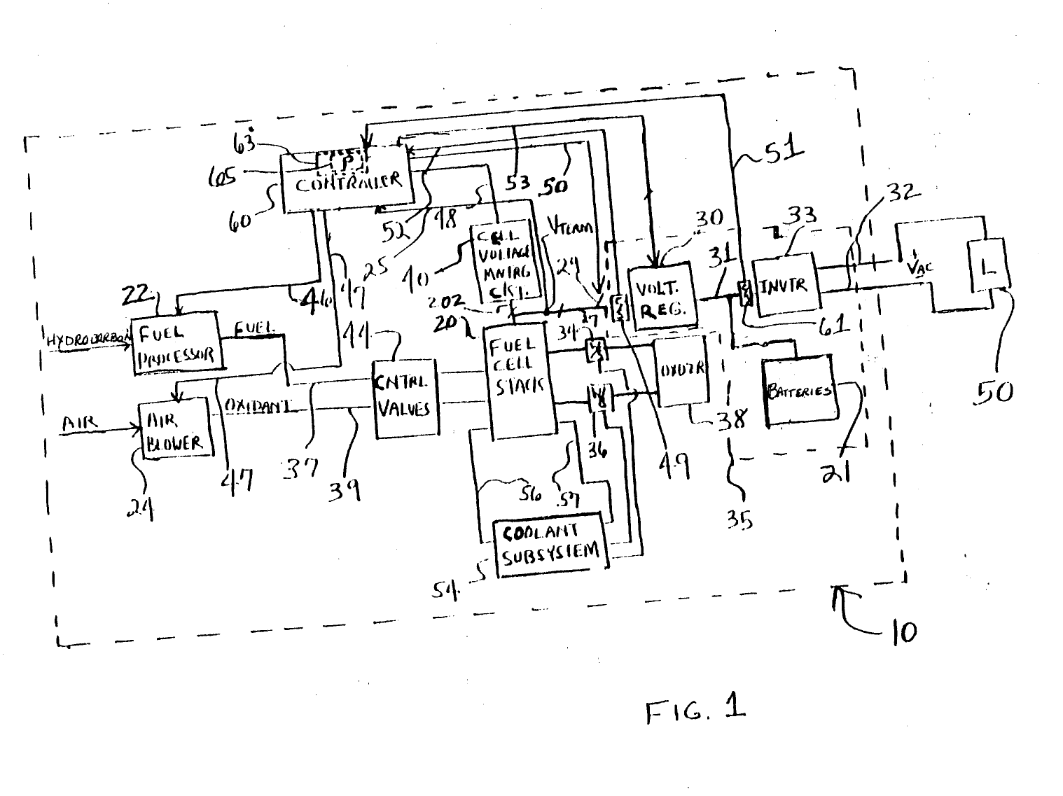

Referring to FIG. 1, an embodiment of a fuel cell system 10 in accordance with the invention includes, among other components, a fuel cell stack 20, a fuel processor 22 (a reformer, for example) and an air blower 24. The fuel cell stack 20 produces power for a load 50 in response to fuel and oxidant (i.e., reactant) flows that are provided by the fuel processor 22 and the air blower 24, respectively. More specifically, the fuel cell system 10 controls the power that is produced by the fuel cell stack 20 by controlling the fuel processor 22 to regulate the fuel flow that the processor 22 provides to the stack 20.

In some embodiments of the invention, the fuel cell system 10 supplies power to a particular house, or residence; and the load 50 collectively represents all of the electrical loads (at the particular residence) that are currently consuming power from the fuel cell system 10. For example, at a particular moment, the load 50 may represent the electrical load created by an electrical furnace, an air conditioner, a microwave, a television, light fixtures and an electric water heater that are all drawing power from the fuel cell system 10. The specific loads (of the residence) that form the load 50 change with time. Therefore, the power that is demanded by the load 50 (i.e., the “power demand”) is not constant with respect to time, but rather, the power demand varies with time according to the time of day, weather conditions, the changing habits of users, the number of current occupants in the residence, etc.

As described below, in some embodiments of the invention, the fuel cell system 10 creates and regularly adapts (i.e., updates) a model for purposes of predicting the future power demand from the load 50. The fuel cell system 10 uses the power demand predictions that are provided by this model to more efficiently control one or more operations of the system 10, depending on the particular embodiment of the invention.

For example, in some embodiments of the invention, the fuel cell system 10 uses the model to control the charging of batteries 21, devices that serve as “power buffers” to accommodate sudden power increases in the power that is demanded by the load 50. More specifically, the batteries 21 provide supplemental power for the fuel cell system 10 to accommodate fuel processor's inability to instantaneously respond to a rapid increase in the load's power demand. The fuel cell stack 20 (that relies on an increased fuel flow rate to supply additional power when the power demand increases) may not be able to instantaneously provide enough power to meet the increased power demand. However, during the time in which the fuel processor 22 is ramping up its fuel output (in response to an increase in the power demanded by the load 50), the fuel cell system 10 relies on stored energy in the batteries 21 to provide the needed additional power to the load 50.

The batteries 21 store a finite amount of energy, and therefore, it may be important to ensure that a sufficient charge exists on the batteries 21 before the next power surge. Unlike conventional fuel cell systems, the fuel cell system 10 does not continuously charge the batteries 21 when the batteries 21 are not supplying power to the load 50. Instead, the fuel cell system 10 uses the future power demand that is indicated by the model to regulate the charging of the batteries 21 in response to an anticipated, or future, power demand. More specifically, in some embodiments of the invention, the fuel cell system 10 only charges the batteries 21 in anticipation of a significant increase in the load's power demand (i.e., an increase in which supplemental power is needed from the batteries 21) instead of continuously maintaining a high charge on the batteries 21. Thus, by only charging the batteries 21 before periods in which energy from the batteries 21 is needed, both the power efficiency of the system 10 is improved and the performance of the system 10 is maintained, as compared to conventional fuel cell systems.

In addition to or as an alternative to using the future power demand indications from the model to control when the batteries 21 are charged, the fuel cell system 10 may use the model to control other operations. For example, in some embodiments of the invention, the fuel cell system 10 may control when the system 10 enters an idle mode of operation, when an output of the fuel processor 22 is increased/decreased, when an output power of the fuel cell system 10 is increased/decreased, etc., based on the future power demand that is predicted by the model. An idle state or mode of operation is a state/mode of the system 10 in which the system 10 cuts off the fuel flow to the fuel cell stack 20 (i.e., bypasses the fuel cell stack 20), thereby relying on the power that is provided by the batteries 21.

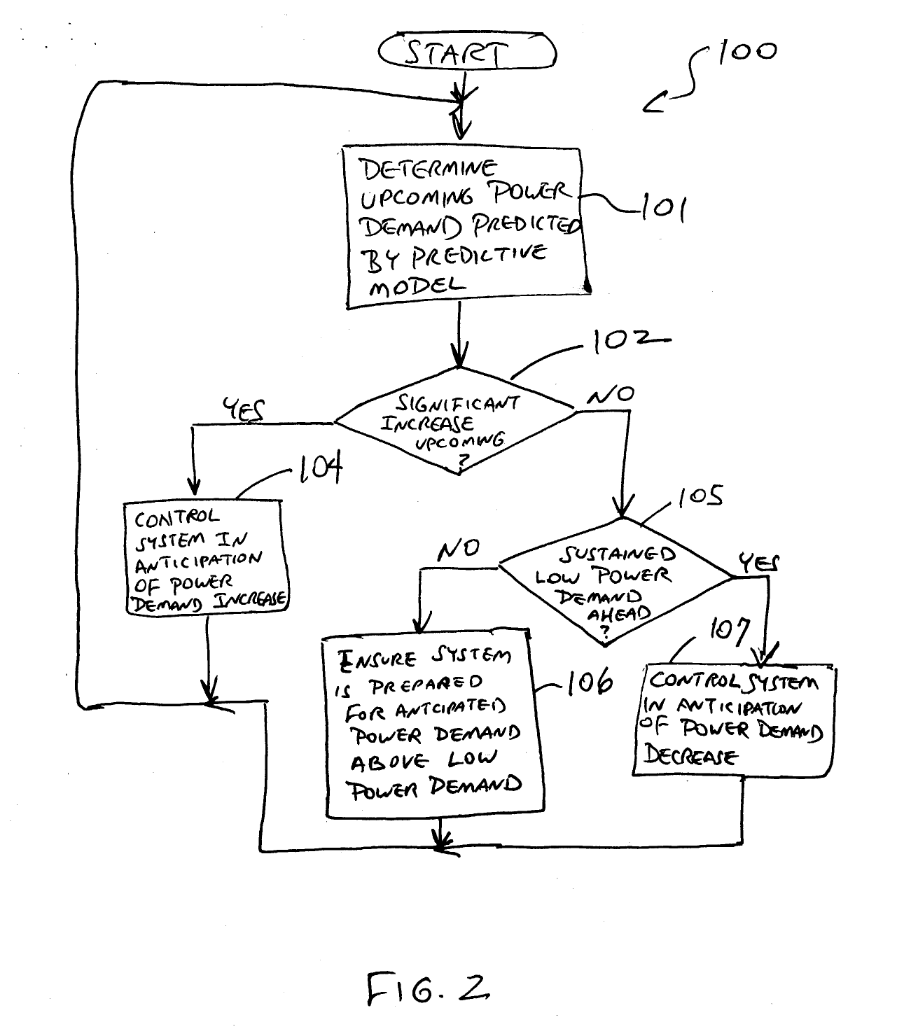

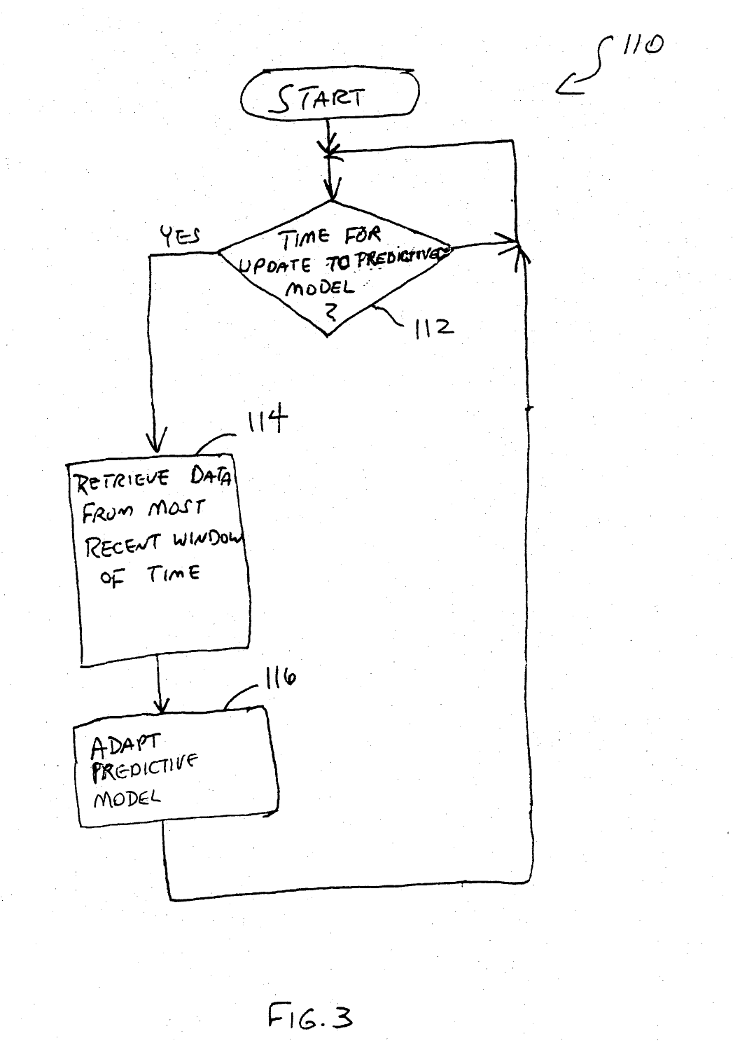

As a more specific example, FIG. 2 depicts a technique 100 that the fuel cell system 10 uses in connection with the model in accordance with some embodiments of the invention. In the technique 100, the fuel cell system 10 determines (block 101) the upcoming power demand that is predicted by the model. More particularly, the control decisions performed by the fuel cell system 10 may depend on whether the model predicts an upcoming period of decreased power demand, an upcoming period of increased power demand or an upcoming period in which the power demand remains essentially the same as the current power demand. Depending on the particular embodiment of the invention, the upcoming period may be a given number of seconds, minutes or hours (as examples).

After determining the upcoming power demand (as predicted by the model), the fuel cell system 10 determines (diamond 102) whether a significant increase in power demand is upcoming. In some embodiments of the invention, a significant increase in power demand is an increase that momentarily requires supplemental power from the batteries 21 or some other change in the system 10. In accordance with some embodiments of the invention, if the model predicts that such a significant power demand is about to occur (occur within the next three hours or next day, as examples), the fuel cell system 10 controls the system 10 in anticipation of the power demand increase, as depicted in block 104. As a more specific example, this control may include charging the batteries 21 (or at least initiating the charging of the batteries 21), increase an output power of the fuel cell stack 20, ramping up the fuel output from the fuel processor 22, etc. Control proceeds from block 104 back to block 101.

If the model predicts that a significant increase in power demand is not about to occur, then the fuel cell system 10 determines (diamond 105) whether a sustained period of low power is ahead. If so, the fuel cell system 10 controls the system 10 in anticipation of a power demand decrease, as depicted in block 107. As a more specific example, this control may include placing the system 10 in a idle state in which the fuel processor 22 continues to run; but the fuel cell stack 20 is bypassed, and power to the load 50 is provided by the batteries 21. Control proceeds from block 107 back to block 101.

If the model predicts that a period of sustained low power demand is not ahead, then the system 10 prepare for an anticipated power demand above the low power demand level, as depicted in block 106. For example, the system 10, in anticipation of a power demand above a low power demand, may transition from an idle state (if currently in an idle state) into a normal state of operation. Other variations are possible.

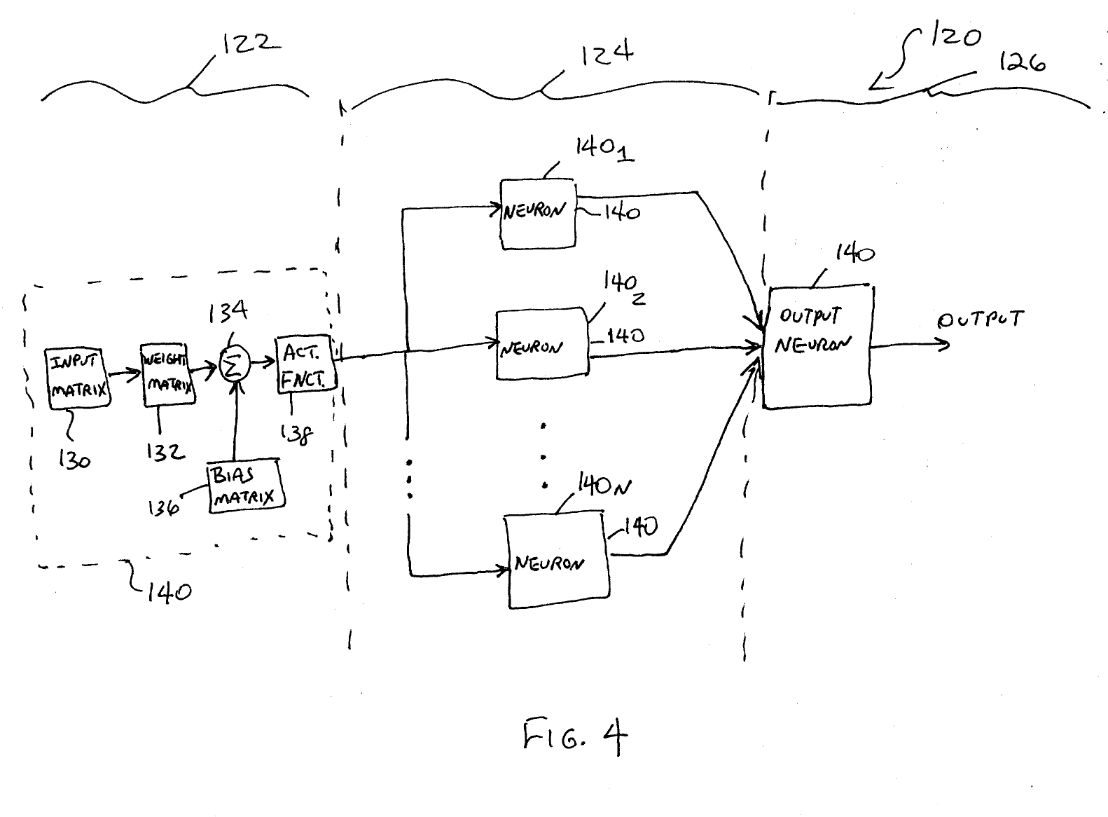

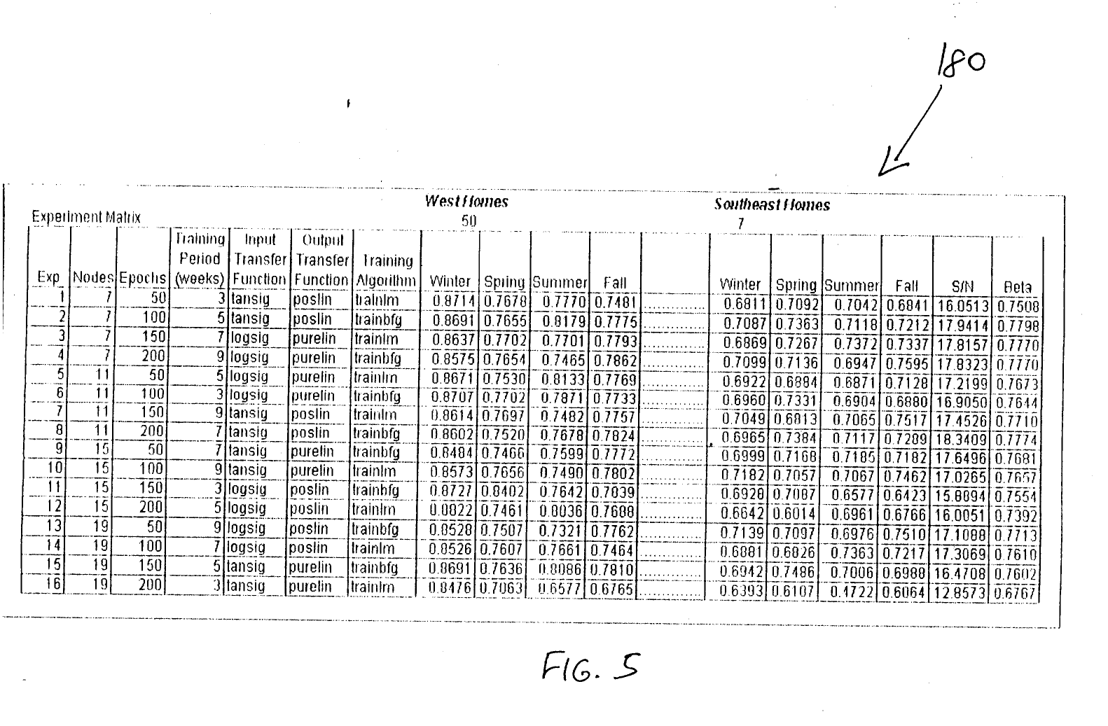

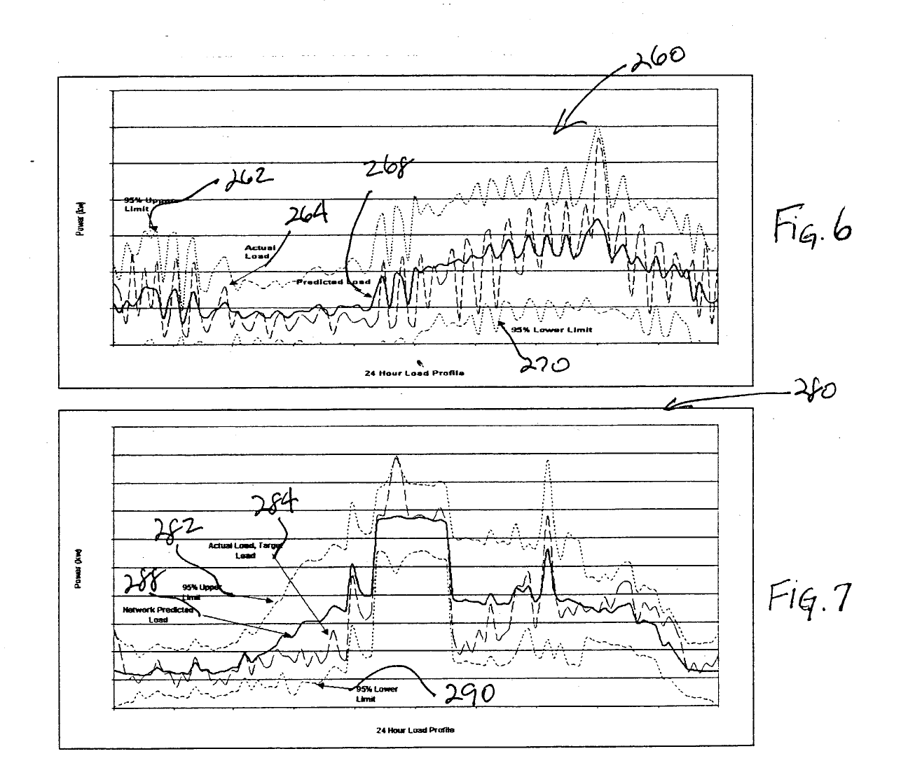

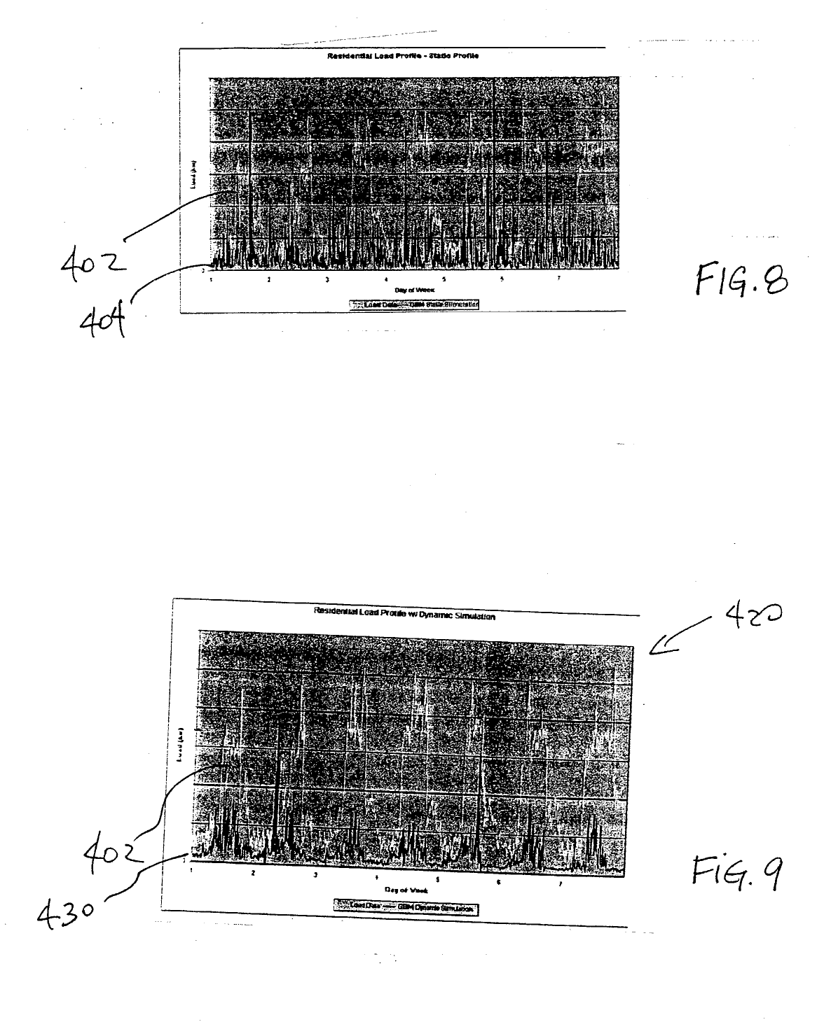

In some embodiments of the invention, the fuel cell system 10 uses an artificial neural network (ANN) to form the model. ANN has some major advantages over other load forecasting tools: it can model with high accuracy a data set that is nonlinear and interactive by learning the general patterns associated between the input(s) and the expected output(s). Referring to FIG. 4, an ANN 120 in accordance with the invention includes three layers: an input layer 124, a middle or hidden layer 124 (although there could be several) and an output layer 126. Each input element to the model is connected to each neuron contained in the hidden layer. In turn, the hidden layer is then connected to the output neuron(s). This type of network in which all elements flow in one direction from inputs to outputs is called a feedforward network. It is through these interconnections that ANN can have high accuracy when modeling nonlinear functions.

As depicted in FIG. 4, each neuron 140 includes an input matrix 130 that contains the input values for the ANN 120. These input values include values that affect the power that is demanded by the load 50. For example, the input values include values indicative of the weather, the time of day, the season of the year, the number of occupants in the house, etc. Each neuron 140 also includes a weight matrix 132 that assigns a weight, or value, to assess the strength of each input value relative to the output (i.e., the predicted power demand). The product of the inputs to the neuron 140 and the weights provided by the weight matrix 132 are added (via a summer 134 of the neuron 140) to bias values formed from a bias matrix 136. The summation is provided to an activation function 138. As shown in FIG. 4, the output of the activation function forms the output of the particular neuron 140. As depicted in FIG. 4, the hidden layer 124 may include multiple neurons (neurons 140₁, 140₂ . . . 140_{N}, as examples).

In order to determine the weights at each neuron, the fuel cell system 10 trains the ANN 120. Training is the process by which the weights and biases are optimized to minimize the overall error of the network. To train the network, the training set, which is formed from input values paired with their respective target value, is passed through the network. There are certain precautions to be aware of prior to training, and they are primarily related to proper generalization. The concept behind training is for the network to learn the general relationship between the input and output values. Therefore, a large data set that is representative of the sample space needs to be used. For example, the ideal load data used in training would represent all load usage characteristics related to the home. If too small a data set has been used during training that is not representative of the entire sample space, the network will not learn the general pattern. It will then perform poorly during simulation or use on board the fuel cell system.

Prior to training, the fuel cell system 10 randomly initializes weight and bias values at all nodes. The inputs are passed through the network to produce an output, which is then compared to a target value. Depending upon the error between the output and the target, the fuel cell system adjusts the network weights and biases. The fuel cell system 10 continues this technique until the weights and biases produce a minimum performance error.

Point predictions with neural networks are subject to the same type of uncertainty questions as regression or any other modeling tool. It is therefore desirable to characterize the uncertainty of the prediction with some type of prediction interval. The width of the interval would be an integral part of the intelligent control algorithm. Unfortunately, unlike regression, standard methods for prediction interval estimation are not readily available for neural networks and are still the subject of debate. An added complication is the fact that residential power usage is a stochastic process and both the mean value and the variance change in time. The total variability of neural network predictions like all model predictions can be thought of as having a model uncertainty component S²ₘ and a noise component S²ᵥ(x). The general approach is to estimate the model uncertainty by characterizing the change in network performance with respect to changes in the network weights. The noise component can be estimated using a separate network that models the variance as a function of the inputs.

An estimate of the model uncertainty may be made, making use of the Jacobian and Hessian matrices, calculated as part of backpropagation training algorithms. The Jacobian, J, is the matrix of the first derivatives of the network errors with respect to the weights and biases. The Hessian, H, is the matrix of second derivatives. The inverse of the Hessian is regarded as an unbiased estimate of the variance/covariance matrix with respect to network weights and biases.

To derive an estimate of the model uncertainty, the performance gradient is first estimated:

∇g=J^{T}E, Eq. 3

where “∇_{g}” represents the gradient of the error function, and “E” represents the network error (i.e., the difference between the actual and predicted load values) Using Eq. 3 the model uncertainty, S²ₘ, can be estimated as follows:

S²ₘ=∇g^{T}H⁻¹∇g, Eq. 4

From a separate neural network (or additional layer) with exponential activation function the noise component S²ᵥ(x)n is estimated as a function of the input vector. The following prediction interval may be used:

ŷ(xn+1)±t_{(1-a/2,n-(d-2)k-1)}Sv(xn+1)\sqrt{1+S²ₘ}, Eq. 5

where “ŷ” represents the predicted response to the input set xₙ₊₁, “t” represents the students distribution, “n” represents the number of training points, “d” represents the number of input variables, and “k” represents the total number of estimated weights and biases.

The ANN is defined by a variety of different parameters, such as the number of nodes; the number of samples, or epochs; the length of the training period; and the type of training algorithm that is used to adapt the ANN to predict future power demand. The following represents the result of an experiment that was set up to test ten homes across two geographical locations and during all four seasons. The measure of prediction accuracy used in the experiment was the R² value, the difference attained between the simulated network prediction method versus the actual data.

The results of the experiment are depicted in a table 180 in FIG. 5. The most robust network architecture is the architecture that maximizes the signal-to-noise ratio for all parameters. From the table 180 the number of nodes in the hidden layer required for the most robust network from this experiment was either 7 or 11. This supports the idea that a small amount of neurons in the hidden layer is important for generalization of the function. To many neurons result in overfitting, this explains why the ANN with 19 nodes (see FIG. 5) had the lowest signal-to-noise ratio of the simulation set. When overfitting occurs, the network has “memorized” the relationship between the input and output data of the training set, instead of learning it.

FIG. 5 also depicts in the table 180, too many epochs allow the network to begin memorizing the relationship between input and output, rather than only learning it. Similarly, the SNR generally increases with the training period (in weeks). As a particular training period, the SNR is maximized. A longer training period contained more examples of time-load relationships and patterns that reappear in the simulation set.

Regarding the choice of training algorithms, the quasi-Newton algorithm outperformed the Levenberg-Marquardt algorithm. Both algorithms are considered iterative, meaning they continue training until the error function reaches a minimum. If the error begins to increase, then the training ends. One more potential problem with this approach is that if the algorithm reaches a local minimum, the error would have to increase in order to contain training to find the global minimum. These algorithms do not allow this, so that the performance may be called at a local minimum. The same applies for saddle points, or very flat areas on the error plane. This is why the performance of the training algorithms are subject to the initial choice of weight and biases. Performance may also depend however, on the speed on which the algorithm converges. Because the Levenberg-Marquardt algorithm moves faster (or takes steeper steps) towards convergence, this algorithm may be more likely to get stuck at a saddlepoint or a local minimum than the quasi-Newton algorithm. This may account for the improved performance of the latter training algorithm.

As depicted in FIG. 5, for the hidden layer, the log sigmoid activation function outperformed the tansig activation function. Furthermore, as depicted in FIG. 5, as shown, the poslin activation function outperforms the purelin activation function at the output neuron.

In some embodiments of the invention, the fuel cell system 10 may use the following parameters for the ANN: a three-layer feedforward network used with seven nodes at the hidden layer, a “logsig” activation function at the hidden layer and a “poslin” transfer function at the output neuron. Furthermore, in some embodiments of the invention, the training period may be nine weeks, and the network training algorithm may be the quasi-Newton backpropagation algorithm. Furthermore, in some embodiments of the invention, 150 epochs may be used for training.

FIG. 6 depicts results from load predictions for one day from a home in the western part of the United States during the month of May. As shown, a graph 268 of the load that is predicted by the ANN follows a graph 264 of the actual load of the house. Also depicted in FIG. 7 are graphs 262 and 270 of the 95 percent upper and 95 percent lower, respectively, limits.

FIG. 8 depicts the results of load predictions from a home in the southeastern part of the United States in the summer. As shown in FIG. 8, a graph 288 of the predicted load closely follows a graph 284 of the actual load. Also depicted in FIG. 8 are graphs 282 and 290 of the 95 percent upper and lower, respectively, limits.

In some embodiments of the invention, the fuel cell system 10 may base the load prediction model on Geometric Brownian Motion (GBM). More specifically, residential power usage may be modeled as a continuous time, continuous state Markov random walk. In other words, it is fair to say that for all practical purposes load usage is a continuous variable, even in a small home given the variable load requirements of blowers, compressors and pumps, among other things. Continuous-time, continuous-state Markov processes are governed by the laws of GBM.

GBM may be described by the following stochastic differential equation with L(t) representing the change in residential power usage in time:

dL(t)=μL(t)dt+σL(t)dZ Eq. 6

,where “L(t)” represents power load at time “t”, “μ” represents drift associated with the load, “σ” represents volatility associated with the load, “dZ”represents Weiner increment=N(0,1)dt and N(0,1) represents standard normal distribution.

Dividing through by L(t) and applying Ito's Lemma with F(L(t),t)=1n(L(t), the following relationship is obtained:

$$dF = ( μ - \frac{{σ}^{2}}{2} ) dt + σ dZ \qquad Eq . 7$$

This stochastic differential equation has an explicit solution that lends itself well to Monte Carlo simulation, as shown below:

$$L ( t ) = {L}_{0} {ⅇ}^{[ ( μ \frac{{σ}^{2}}{2} ) t + σ N ( 0 , 1 ) \sqrt{t} ]} \qquad Eq . 8$$

The following is a simple method for estimating the parameters (μ−σ2/2) and σ.

Calculated from the data:

$$δ = \frac{ln ( L ( {t}_{i} ) ) - ln ( L ( {t}_{i - 1} ) )}{Δ t} \qquad Eq . 9$$

,where σ represents the instantaneous drift.

The parameter,

$${}^{``} \frac{μ - {σ}^{2}}{2} = \overline{δ} {,}^{″}$$

the mean of the data, and “σ” is just the standard deviation of all δ.

FIG. 8 depicts a GBM simulated profile 404 and a graph 402 of actual load data for a day. The simulation was conducted using Eq. 4 above. The drift and volatility parameters are constants, estimated from the previous days data.

As shown in FIG. 9, this “static” GBM model may perform a generally inadequate job predicting residential load usage. By definition, in this model, the drift and volatility parameters are constants. Even with accurate estimates the model is not capable of accommodating anything more than linear changes in drift and volatility. However, in some embodiments of the invention, the fuel cell system 10 converts the “static GBM” model into a “dynamic GBM model” by modeling drift and volatility parameters as functions of time.

In this manner, neural network modeling may be used for purposes of drift and volatility modeling and assessing the prediction accuracy of this dynamic GBM simulation in comparison to results outlined above. The σ parameter was calculated for the load data of a particular home as well as a five point moving drift and volatility.

Volatilities are variances and as such are X² distributed. The actual distribution of the volatilities was sufficiently close to exponential such that a log transformation rendered it nearly normal. The same feedforward backpropagation type training was used to model both the moving drift and the moving log of the volatilities. In the dynamic GBM model, the fuel cell system 10 uses Eq. 8 to derive the model and replaces the drift and volatility parameters with the time-dependent versions of these parameters provided by artificial neural networks. The simulation R-values for the modeled drift and volatility when compared to actual data were 0.98 and 0.74 respectively.

FIG. 9 depicts the resultant graph 430 when the drift and volatility parameters are modeled to depend on time. In FIG. 9 it is apparent that patterns begin to emerge in the predictions (the R value of these predictions is about 0.5 for reference). The scale and magnitudes of the predictions are not yet close to the actual data however the accuracy is considerably improved over the static drift and volatility predictions above.

To summarize, the predictive models used by the fuel cell system 10 may be derived either from a sole neural networks or from a combination of geometric brownian motion with dynamic models for the drift and volatility parameters, in accordance with some embodiments of the invention.

Referring back to FIG. 1, in some embodiments of the invention, the fuel cell system 10 includes a controller 60 that executes program instructions 65 that are stored in a memory 63 (of the system 10). These program instructions cause the controller 60 to perform one or more routines that are related to creating, maintaining and adapting, the predictive models that are described above, as well as performing the techniques shown in FIGS. 1 and 2.

In some embodiments of the invention, the controller 60 may include a microcontroller and/or a microprocessor to perform one or more of the techniques that are described herein when executing the program 65. For example, the controller 60 may include a microcontroller that includes a read only memory (ROM) that serves as the memory 63 and a storage medium to store instructions for the program 65. Other types of storage mediums may be used to store instructions of the program 65. Various analog and digital external pins of the microcontroller may be used to establish communication over electrical communication lines that extend to various components of the fuel cell system 10, such as electrical communication lines 25, 46, 47, 50, 51, 52 and 53 and the serial bus 48. Electrical interferences (not shown) may be coupled between these lines and the controller 60. In other embodiments of the invention, a memory that is fabricated on a separate die from the microcontroller may be used as the memory 63 and store instructions for the program 65. Other variations are possible.

In some embodiments of the invention, the fuel cell system 10 regulates the charging of the batteries 21 by regulating the amount of power that is produced by the fuel cell stack 20. More specifically, in some embodiments of the invention, to charge the batteries 21, the fuel cell system 10 controls the fuel cell stack 20 so that the stack 20 produces more power than is consumed by the load 50 and the various parasitic equipment of the fuel cell system 10 that draws power from the stack 20. This excess power, in turn, charges the batteries 21. Conversely, when the fuel cell stack 20 produces generally the same level of power that is consumed by the parasitic equipment of fuel cell system 10 and the load 50, then the batteries 21 are generally not charged.

Thus, in some embodiments of the invention, the fuel cell system 10 controls the output power from the fuel cell stack 20 for purposes of controlling and charging of the batteries 21. One way to control the output power is to control the current from the fuel cell stack 20.

In some embodiments of the invention, the controller 60 regulates the current that is provided by the fuel cell stack 20 by controlling the input impedance of power conditioning circuitry 35 of the fuel cell system 10. The power conditioning circuitry 35 is coupled between the terminals of the fuel cell stack 20 and the load 50. Thus, DC voltage output terminals 31 of the fuel cell stack 20 are coupled to the input terminals of the power conditioning circuitry 35. The DC terminal output voltage (called “V_{TERM}”) of the fuel cell stack 20 is relatively constant. Therefore, by controlling the input impedance of the power conditioning circuitry 35, the controller 60 effectively controls the current that is provided by the fuel cell stack 20 through its output terminals 31.

In general, the power conditioning circuitry 35 dampens transient load conditions as seen from the stack 20 and converts the V_{TERM} voltage from the stack 20 into a regulated AC voltage (called “V_{AC}”) that is received by the load 50. More specifically, in some embodiments of the invention, the power conditioning circuitry includes a DC-to-DC voltage regulator 30, the batteries 21 and an inverter 33. The voltage regulator 30 is coupled to the output terminals 27 of the fuel cell stack 20 to receive the V_{TERM} stack voltage. The voltage regulator 30 converts the V_{TERM} stack voltage into a regulated output voltage that appears on an output terminal 31 of the regulator 30. The batteries 21 are coupled to the output terminal 31 of the regulator 30. An input terminal of a DC-to-AC inverter 33 is coupled to the output terminal 31. The inverter 33 converts the DC voltage that appears on the output terminal 31 into the regulated V_{AC} voltage that is furnished across output terminals 32 of the inverter 33 to the load 50.

The power conditioning circuitry 35, in some embodiments of the invention, provides indications of various parameters to the controller 60, including, for example, the stack current, the V_{TERM} stack voltage, the current in the load 50, etc. For example, the power conditioning circuitry 35 may provide an indication of the stack current to the controller 60 via a current sensor 49 that is coupled in series with an input terminal of the voltage regulator. In this manner, the current sensor 49 furnishes a signal indicative of the stack current to a communication line 52 that is coupled to the controller 60. The controller 60 may use this indication as, for example, feedback to regulate the input impedance of the power conditioning circuitry 35 so that the desired stack current is achieved.

As another example of parameters that the power conditioning circuitry 35 may indicate to the controller 60, the power conditioning circuitry 35 may provide an indication of the current in the load 50 via a current sensor 61 that is coupled in series with an input terminal of the inverter 33. In this manner, the current sensor 61 furnishes a signal indicative of the load current to a communication line 51 that is coupled to the controller 60. As another example, the power conditioning circuitry 35 may provide an indication of the V_{TERM} stack voltage to the controller 60 via a communication line 25. Various other and different parameters may be communicated between the power conditioning circuitry 35 and the controller 60.

In some embodiments of the invention, the controller 60 controls the input impedance of the power conditioning circuitry 35 by controlling the input impedance of the voltage regulator 30. As an example, in some embodiments of the invention, the voltage regulator 30 may be a switching regulator, and the controller 60 may communicate with the voltage regulator 30 to control the regulator's input impedance via one or more control communication lines 53. For example, the controller 60 may use the communication line(s) 53 to regulate the switching frequency of the voltage regulator 30 and/or regulate the duty cycle of the voltage regulator 30 for purposes of controlling the regulator's (and the power conditioning circuitry's) input impedance. Thus, by modifying the duty cycle and/or switching frequency of the voltage regulator 30, the controller 60 adjusts the stack current, in some embodiments of the invention. Therefore, to increase the current from the fuel cell stack 20, the controller 60 interacts with the voltage regulator 30 to lower the regulator's input impedance, and to decrease the current from the fuel cell stack 20, the controller 60 interacts with the voltage regulator 30 to increase the regulator's input impedance.

Among the other features of the fuel cell system 10, the system 10 may include a cell voltage monitoring circuit 40 that provides indications of individual cell voltages to the controller 60 via a serial bus 48. The fuel cell system 10 may also include a switch 29 that is controlled by the controller 60 (via a communication line 50) for purposes of isolating the fuel cell stack 20 from the power conditioning circuitry 35 in response to a shut down of the fuel cell stack 20. The fuel cell system 10 may also include control valves 44 that provide emergency shutoff of the oxidant and fuel flows to the fuel cell stack 20. The control valves 44 are coupled between inlet fuel 37 and oxidant 39 lines and the fuel and oxidant manifold inlets, respectively, to the fuel cell stack 20. The inlet fuel line 37 receives the fuel flow from the fuel processor 22, and the inlet oxidant line 39 receives the oxidant flow from the air blower 24. The fuel processor 22 receives a hydrocarbon (natural gas or propane, as examples) and converts this hydrocarbon into the fuel flow (a hydrogen flow, for example) that is provided to the fuel cell stack 20.

The fuel cell system 10 may include water separators, such as water separators 34 and 36, to recover water from the outlet and/or inlet fuel and oxidant ports of the stack 22. The water that is collected by the water separators 34 and 36 may be routed to a water tank (not shown) of a coolant subsystem 54 of the fuel cell system 10. The coolant subsystem 54 circulates a coolant (de-ionized water, for example) through the fuel cell stack 20 to regulate the operating temperature of the stack 20. The fuel cell system 10 may also include an oxidizer 38 to burn any fuel from the stack 22 that is not consumed in the fuel cell reactions.

Other embodiments are within the scope of the following claims. For example, in other embodiments of the invention, the model that is used to predict the power demand of the load may be 1.) a time series model, such as an Autoregressive Integrated Moving Average model (ARIMA); a 2.) an econometric model; 3.) a model that is a hybrid of a time series model and an econometric model; a 4.) a nonparametric/semiparametric regression-based model; a 5.) a fuzzy logic-based model; or 6.) a model that is a hybrid formed from an artificial neural network and fuzzy logic. Other models and other variations also fall within the scope of the appended claims.

While the invention has been disclosed with respect to a limited number of embodiments, those skilled in the art, having the benefit of this disclosure, will appreciate numerous modifications and variations therefrom. It is intended that the appended claims cover all such modifications and variations as fall within the true spirit and scope of the invention.

What is claimed is:

1. A method usable with a fuel cell system, comprising:
using the fuel cell system to provide power to a load;
providing a model indicating a future power demand from the load; and
regulating an operation of the fuel cell system in response to the future power demand indicated by the model.

2. The method of claim 1, wherein the regulating comprises:
regulating charging of a battery used to provide supplemental power to the load.

3. The method of claim 2, wherein the regulating the charging of the battery comprises:
charging the battery in response to the model indicating an upcoming increase.

4. The method of claim 1, wherein the regulating comprises:
regulating when the fuel cell system enters an idle power state.

5. The method of claim 1, wherein the providing comprises:
providing an artificial neural network that indicates the future power demand.

6. The method of claim 5, further comprising:
providing data indicative of an actual power demanded by the load over a window of time; and
adapting the network to indicate the future power demand in response to the data.

7. The method of claim 6, further comprising:
moving the window in time and repeating the adapting in response to data associated with the moved window of time.

8. The method of claim 1, wherein the providing comprises:
modeling the load using Geometric Brownian Motion.

9. The method of claim 8, wherein the modeling comprises:
modeling a dependence of a drift parameter associated with the load on time.

10. The method of claim 8, further comprising:
modeling a drift parameter associated with the load using an artificial neural network.

11. The method of claim 9, wherein the modeling comprises:
modeling a dependence of a volatility associated with the load on time.

12. The method of claim 10, wherein the modeling comprises:
using an artificial neural network to model a volatility associated with the load on time.

13. A fuel cell system comprising:
a fuel cell stack to provide power to a load; and
a circuit adapted to provide to a model indicating a future power demand from the load and regulate an operation of the fuel cell system in response to the future power demand indicated by the model.

14. The system of claim 13, wherein the circuit regulates the charging of a battery.

15. The system of claim 14, wherein the circuit charges the battery in response to the model indicating an upcoming increase in power demanded by the load.

16. The system of claim 13, wherein the circuit regulates when the fuel cell system enters an idle power state.

17. The system of claim 13, wherein the circuit provides an artificial neural network indicating the future power demand.

18. The system of claim 17, wherein the circuit adapts the network to indicate the future power demand in response to data indicative of an actual power demanded by the load.

19. The system of claim 18, wherein the circuit moves the window in time to adapt the network again in response to data associated with the novel window of time.

20. The system of claim 13, wherein the circuit models the load using Geometric Brownian Motion.

21. The system of claim 20, wherein the circuit determines a dependence of a drift parameter associated with the load with respect to time.

22. The system of claim 20, wherein the circuit models a drift parameter associated with the load using an artificial neural network.

23. The system of claim 20, wherein the circuit determines a dependence of a volatility associated with the load with respect to time.

24. The system of claim 20, wherein the circuit models a volatility associated with the load using an artificial neural network.
